(19) United States
(12) Patent Application Publication
(10) Pub. No.: US 2010/0209701 A1
(43) Pub. Date: Aug. 19, 2010

(54) METHOD FOR MANUFACTURING TRANSPARENT PLASTIC FILM AND TRANSPARENT PLASTIC FILM MANUFACTURED BY THE METHOD

(75) Inventors: Gi-Cheul Kim, Daejeon Metropolitan City (KR); Dong-Ryul Kim, Daejeon Metropolitan City (KR); Hee-Jung Kim, Daejeon Metropolitan City (KR); Ju-Eun Cha, Daegu Metropolitan City (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 12/452,326

(22) PCT Filed: Jun. 27, 2008
(86) PCT No.: PCT/KR2008/003749

§ 371 Date: Apr. 22, 2010

(30) Foreign Application Priority Data
Jun. 28, 2007 (KR) 10-2007-0064675

(51) Int. Cl. B32B 5/16; C08L 63/00; C08K 3/40

(52) U.S. Cl. 428/325; 523/466; 523/444

(57) ABSTRACT

The present invention provides a method for producing a transparent plastic film, which comprises the steps of (a) preparing a glass flake particle; (b) preparing a curable epoxy resin in which a difference between a refractive index after the curable epoxy resin is cured and a refractive index of the glass flake particle is not more than 0.01; (c) mixing the curable epoxy resin and the glass flake particle with each other; and (d) curing a mixture of the curable epoxy resin and the glass flake particle to form an epoxy curing substance that includes the glass flake particle, and a transparent plastic film that is produced by using the same.

### TECHNICAL FIELD

The present invention relates to a method for producing a transparent plastic film in which a refractive index of a curable epoxy resin is controlled on the basis of a refractive index of a glass flake particle to produce the transparent plastic film and a transparent plastic film that is produced by using the same.

This application claims priority benefits from Korean Patent Application No. 2007-0064675, filed on Jun. 28, 2007, the entire content of which is fully incorporated herein by reference.

### BACKGROUND ART

A glass substrate used for display device, picture frame, industrial arts, vessels and the like has various advantages such as small coefficient of linear expansion, excellent gas barrier property, high optical transmittance, surface flatness, excellent resistance to heat, excellent resistance to chemicals and the like, but disadvantages in that it is weak against impact, easily broken, and high in density, thus heavy.

Currently, while the concern about a liquid crystal or an organic luminescent display device, and the electronic paper rapidly increases, the research for replacing these substrates by plastic is actively progressed in the glass.

If the glass substrate is replaced with the plastic film which is the base substrate and the plastic substrate having functional coating layer, the total weight of the display device can became lighter, the flexibility of design can be given, and it is hard against impact, and in the case of when it is produced by using a continuous process, it may have the economic efficiency in comparison with the glass substrate.

Here, in order to be used as the base substrate of the plastic substrate for a display device by the plastic film processing temperature of the transistor device, high glass transition temperature that is capable of enduring the temperature of deposition of the transparent electrode, oxygen and steam intercepting property for preventing the aging of liquid crystal and organic luminescence material, small coefficient of linear expansion and dimensional stability for preventing the distortion of the substrate according to a change in the processing temperature, high mechanical strength that is compatible with the processing device used for the known glass substrate, resistance to chemicals that can endure the etching process, high optical transmittance, small birefringence rate, scratch resistance of the surface, and the like are required.

Among these essential conditions, as a known study for satisfying the condition of the small coefficient of linear expansion, a method for producing the plastic film by adding an inorganic filler such as clay, glass fiber, and glass cloth to a polymer material may be exemplified.

However, there is a problem in that it is difficult to produce a plastic film by uniformly dispersing the inorganic filler such as the clay and the glass fiber in the polymer material, and in order to provide the effect for reducing the coefficient of linear expansion of the produced plastic film since the inorganic filler is included in a great amount, there is a problem in that it is difficult to make the plastic film light.

On the other hand, in the case of when the inorganic filler such as the above glass cloth is added to the polymer material, the coefficient of linear expansion may be reduced, but it is difficult to remove the bubbles that are present at the interface between the polymer material and the glass cloth, and in this case, there is a problem in that since the inorganic filler is used in a great amount, it is difficult to make it light.

In addition, in the case of when the inorganic filler is added to the polymer material in which the refractive index is not controlled, the coefficient of linear expansion may be reduced, because of the difference between the refractive indexes of the polymer material and the inorganic filler, there is a limit in ensuring of the transparent property that is one of the conditions being satisfied in order to be used as the basic substrate of the plastic substrate for a display device by the plastic film.

### DISCLOSURE OF INVENTION

### Technical Problem

It is an object of the present invention to provide a method for producing a transparent plastic film in which the refractive index of the curable epoxy resin is controlled to produce the transparent plastic film on the basis of the refractive index of the glass flake particle, and a transparent plastic film that is produced by using the same.

### Technical Solution

The present invention provides a method for producing a transparent plastic film, which comprises the steps of (a) preparing a glass flake particle; (b) preparing a curable epoxy resin in which a difference between a refractive index after the curable epoxy resin is cured and a refractive index of the glass flake particle is not more than 0.01; (c) mixing the curable epoxy resin and the glass flake particle with each other; and (d) curing a mixture of the curable epoxy resin and the glass flake particle to form an epoxy curing substance that includes the glass flake particle.

The present invention provides a transparent plastic film and a transparent complex material that comprise a glass flake particle; and an epoxy cured substance which includes the glass flake particle and in which a difference between the refractive index of the glass flake particle and the refractive index of the epoxy cured substance is not more than 0.01.

Provided is an optical film that includes the transparent plastic film according to the present invention.

Provided is a plastic substrate that includes the transparent plastic film according to the present invention.

Provided is an electronic device that includes the transparent plastic film according to the present invention.

### ADVANTAGEOUS EFFECTS

According to the present invention, a method in which the refractive index of the curable epoxy resin is controlled on the basis of the refractive index of the glass flake particle is used, and a difference between a refractive index after the curable epoxy resin is cured and a refractive index of the glass flake particle is not more than 0.01. In addition, a difference between the refractive indexes may be 0 and two refractive indexes may be the same as each other. Therefore, in order to control the refractive index, it is not necessary to separately produce the glass flake particle.

Since the refractive index of the curable epoxy resin is controlled on the basis of the refractive index of the glass flake particle, the transparent property of the film can be easily improved, and the transparent plastic film in which the light transmittance is excellent can be produced.

Since the glass flake is included, the thermal expansion coefficient (CTE) of the film can be reduced, and since the epoxy resin is used, the adhesion strength in conjunction with the glass flake can be improved.

In addition, in the case of when the glass flake particle is added to produce the film, the preferable low thermal expansion coefficient may be provided. In particular, in the case of the glass flake particle in which the depth is in the range of more than 0 and 0.1 μm or less, even when a small amount is added as compared to the added amount of the glass flake particle whose depth is more than 0.1 μm, the low thermal expansion co-efficient capable of being provided when the glass flake particle with the depth more than 0.1 μm is added can be sufficiently provided. That is, in the case of the glass flake particle in which the depth is in the range of more than 0 and 0.1 μm or less, even when a small amount is added, the sufficiently low thermal expansion coefficient may be provided.

In addition, in the case of the glass flake particle in which the depth is in he range of more than 0 and 0.1 μm or less, as described above, in the case when it is in at the glass flake particle or less, since a small amount is added, because the film may be made light. The more thin and light transparent plastic film can be produced.

In the case of when the glass flake particle in which the depth is in the range of more than 0 and 0.1 μm or less and the glass flake particle in which the depth is more than 0.1 μm are added in the same amount to produce the film, two cases can both provide the film that has the preferable low thermal expansion coefficient. However, if the case is compared to the case of the glass flake particle in which the depth is in the range of more than 0 and 0.1 μm or less on the basis of the glass flake particle in which the depth is more than 0.1 μm in the same amount, the case of the glass flake particle in which the depth is in the range of more than 0 and 0.1 μm or less can provide the lower thermal expansion coefficient.

All the case of when the glass flake particle in which the depth is in the range of more than 0 and 0.1 μm or less is added to produce the film and the case of when the glass flake particle in which the depth is more than 0.1 μm is added to produce the film can improve the bending strength, the uniformity, and the transparent property. In particular, in the case of when the glass flake particle in which the depth is in the range of more than 0 and 0.1 μm or less is added, the bending strength, the uniformity, and the transparent property of the film can be more improved.

### BRIEF DESCRIPTION OF THE DRAWINGS

FIG. 1 is an optical picture of a transparent plastic film according to the present invention; and

FIG. 2 is a cross-sectional picture of a transparent plastic film according to the present invention.

### BEST MODE FOR CARRYING OUT THE INVENTION

A method for producing a transparent plastic film according to the present invention comprises the steps of (a) preparing a glass flake particle; (b) preparing a curable epoxy resin in which a difference between a refractive index after the curable epoxy resin is cured and a refractive index of the glass flake particle is not more than 0.01; (c) mixing the curable epoxy resin and the glass flake particle with each other; and (d) curing a mixture of the curable epoxy resin and the glass flake particle to form an epoxy curing substance that includes the glass flake particle.

In the case of the glass flake that is prepared in the step (a), a glass plate (Sheet) that has a predetermined depth (D) is subjected to a pulverizing process to small particles, the glass particles (glass flake) that are produced as described above have the uniform depth but each of the glass particles has a particle size distribution in which the lengths (L) are different from each other. Accordingly, the type of the glass flake may be classified according to the type of the depth, the particle size distribution, and the production material of the glass flake.

As the type of the glass flake that is capable of being used as the glass flake particle that is prepared in the step (a), according to the depth, the type can be classified into depth 0.1 μm (trademark: GF10, manufactured by GlassFlake, Co., Ltd.), depth 0.35 μm (trademark: GF35, manufactured by GlassFlake, Co., Ltd.), depth 0.5 μm (trademark: GF50, manufactured by GlassFlake, Co., Ltd.), depth 0.7 μm (trademark: GF70, manufactured by GlassFlake, Co., Ltd.), and depth 1 μm (trademark: GF100, manufactured by GlassFlake, Co., Ltd.), and among them, the type can be selected.

In addition, examples of the type of the glass flake may include the unmilled glass flake in which 1700 ˜150 μm is 80% and 150 ˜50 μm is 20%; the milled glass flake in which 1000 ˜300 μm is 10%, 300 ˜50 μm is 65%, and 50 μm or less is 25%; and the micronized glass flake in which 150 μm or more is 2%, 150 ˜50 μm is 10%, and 50 μm or less is 88% according to the particle size distribution of the glass flake, and one or more glass flakes that are selected from them may be used. The type of the glass flake that is capable of being used is not limited thereto.

Here, the refractive index of the glass flake is not particularly limited thereto, but it is preferable that it is in the range of 1.5 ˜1.6. The refractive index of the glass flake varies according to the production component of the produced glass, and may be classified into E, C, A, S, D, NE, and T glasses. Among them, in particular, it is preferable that the S, T, and NE glasses are used.

When the glass flake and the curable epoxy resin are closely making contact with each other, since the transparent property of the transparent plastic film or the transparent complex material becomes good, the surface of the glass flake may be treated by using a surface treatment agent that is known in the art, for example, a silane coupling agent. In detail, it is preferable that it is treated by using the compound that includes the epoxy group.

The glass flake particle in the step (a) may be added and can reduce the thermal expansion coefficient (CTE) of the transparent plastic film according to the present invention. In the provision of this effect, the depth of the glass flake particle is not limited thereto.

As an example, in the case of when the glass flake particle in which the depth is in the range of more than 0 and 1 μm or less is added, the thermal expansion coefficient (CTE) can be reduced more as compared to the particle in which the depth is more than 1 μm. In addition, in the case of when the glass flake particle in which the depth is in the range of more than 0 and 0.1 μm or less is added, the thermal expansion coefficient (CTE) can be reduced more and more as compared to the particle in which the depth is more than 0.1 μm.

In detail, after the glass flake particle in which the depth is in the range of more than 0 and 0.1 μm or less is added to produce the film and when the glass flake particle in which the depth is more than 0.1 μm is added, the glass flake particle is added in the same amount as the particle in which the depth is in the range of more than 0 and 0.1 μm or less to produce the film if two films are compared to each other, even though the addition amounts of the glass flake particles of the two films are the same as each other, the film to which glass flake particle in which the depth is in the range of more than 0 and 0.1 μm or less is added provides the lower thermal expansion coefficient than the film to which glass flake particle in which the depth is more than 0.1 μm is added. For example, the thermal expansion coefficient may be reduced by about 3 times.

In addition, in the case of when the thermal expansion coefficient of the film that is produced by adding the glass flake particle in which the depth is in the range of more than 0 and 0.1 μm or less and the thermal expansion coefficient of the film that is produced by adding the glass flake particle in which the depth is more than 0.1 μm are the same as each other, if they are compared to each other, even though the glass flake particle in which the depth is in the range of more than 0 and 0.1 μm or less is added in a smaller amount than the glass flake particle in which the depth is more than 0.1 μm, the low thermal expansion coefficient that is capable of being added in the case of when the glass flake particle in which the depth is more than 0.1 μm is added may be sufficiently provided. For example, if the thermal expansion coefficients of the two films are the same as each other, 20 ppm/K, in the case of the glass flake particle in which the depth is in the range of more than 0 and 0.1 μm or less, if the glass flake particle is added in the content of 20%, the thermal expansion coefficient may be provided, and in the case of the glass flake particle in which the depth is more than 0.1 μm, if the glass flake particle is added in the content of 50%, the thermal expansion coefficient may be provided.

In addition, in the case of the glass flake particle in which the depth is in the range of more than 0 and 0.1 μm or less, as described above, since the glass flake particle may be added in a small amount, the film may be lightened, and the more thin and light transparent plastic film may be produced.

On the other hand, in the case of when the glass flake particle in which the depth is in the range of more than 0 and 1 μm or less is added, as compared to the particle in which the depth is more than 1 μm, the lightness, the bending strength, the uniformity, and the transparent property may be more improved. In addition, in the case of when the glass flake particle in which the depth is in the range of more than 0 and 0.1 μm or less is added, as compared to the particle in which the depth is more than 0.1 μm, the lightness, the bending strength, the uniformity, and the transparent property may be more improved.

As described above, in the case of when the glass flake particle in which the depth is in the range of more than 0 and 0.1 μm or less is used, as compared to the particle in which the depth is more than 1 μm, with the smaller addition amount, the thermal expansion coefficient can be sufficiently reduced, and as compared to the particle in which the depth is more than 0.1 μm, it can provide the added effect in that the thermal expansion coefficient is more reduced.

In addition, in the case of when the glass flake particle in which the depth is in the range of more than 0 and 0.1 μm or less is used, as compared to the particle in which the depth is more than 0.1 μm, it can provide the addition effect in that the lightness, the bending strength, the uniformity, and the transparent property can be more and more improved. Here, since the uniformity is more improved, the glass flake particle per unit depth of the transparent plastic film can be included in a great amount, and the transparent plastic film in which the gas barrier property for intercepting the gas is improved can be produced.

In the step (a), it is preferable that the glass flake particle in which the ratio (L/D) of the length of one glass flake particle per the depth of one glass flake particle is 50 or more is used, and it is more preferable that the glass flake particle in which the ratio of the length of one glass flake particle per the depth of one glass flake particle is 500 or more is used. If the length (L) of the glass flake particle is long, since the path of the gas that flows into the inside of the transparent plastic film may be disturbed, the gas barrier property can be improved. Here, the length of the glass flake particle may be within 300 μm so that the formation of the film is not disturbed, but the length is not limited thereto and the upper limit of the length is not restricted.

In the step (a), the glass flake particle may be mixed with the solvent to prepare a glass flake dispersion solution. In the step (a), the glass flake dispersion solution may be prepared, but is not limited thereto, and a powder type of the glass flake particle may be prepared or a glass flake particle to which a separate additive is added may be prepared.

In the step (a), as the solvent, any solvent that is compatible with epoxy, a curing agent, and the catalyst or is capable of being dissolved thereto may be used, for example, the glass flake dispersion solution may be produced by using one or more solvents that are selected from the group consisting of methyl chloride, dichloroethane, tetrahydrofurane, isooxolane, dioxolan, dioxane, acetone, methyl ethyl ketone, methyl isobutyl ketone, toluene and alcohol. But, the type of the solvent is not limited thereto.

In the step (a), a method for uniformly dispersing the glass flake particle in the glass flake dispersion solution is not particularly limited to a special method, but the glass flake dispersion solution may be subjected to the ultrasonic treatment. The treatment time is not limited, it is possible as long as the dispersibility of the glass flake is excellent, and in particular, it is preferable that it is subjected to the ultrasonic treatment for 1 to 10 min, and it is most preferable that it is subjected to the ultrasonic treatment for 3 min.

In the step (b), the curable epoxy resin may further include 20 to 1000 parts by weight of the curing agent on the basis of 100 parts by weight of the curable epoxy resin.

In addition, in the step (b), the curable epoxy resin may further include 0.1 to 5 parts by weight of the catalyst that is added to the curing agent on the basis of 100 parts by weight of the curable epoxy resin.

In the step (b), it is preferable that the step for preparing the curable epoxy resin comprises (b1) mixing 20 to 1000 parts by weight of the curing agent and 0.1 to 5 parts by weight of the catalyst with each other on the basis of 100 parts by weight of the curable epoxy resin; and (b2) mixing the curing agent to which the catalyst is added and 100 parts by weight of the curable epoxy resin with each other.

More preferably, 182 parts by weight of the epoxy curing agent and 2 parts by weight of the catalyst are mixed with each other, heated, and agitated for 30 min, 100 parts by weight of epoxy that is present in a solid state is agitated for 10 min and melted, and the curing agent to which the catalyst is added and the melted epoxy are mixed with each other and agitated to produce the transparent curable epoxy resin.

In the step (b), since the curable epoxy resin is used as the resin, the adhesion strength in conjunction with the glass flake can be improved.

In the step (b), the curable epoxy resin may be one or more that are selected from an alicyclic epoxy resin that is represented by the following Formula I to Formula 6 and triglycidyl isocyanurate that is represented by the following Formula 7. For example, it is preferable that it is used in a combination with an acid anhydride type curing agent.

These epoxy resins may be used alone or in a combination of two or more species. The refractive index of the resin or the resin combination substance may be the same as the refractive index of the glass flake, and in order to control the refractive index, the other epoxy resins may be used in a combination.

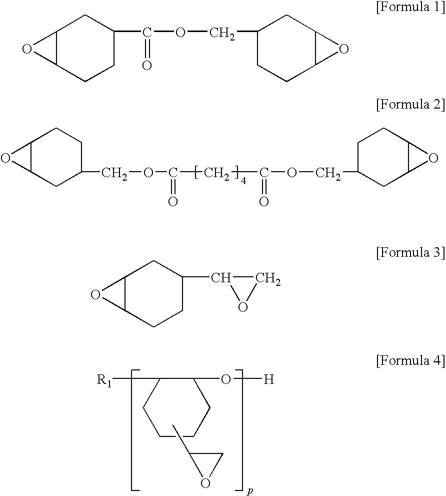

wherein R₁ is a C₁˜C₆ alkyl group or a trimethylolpropane residual group, and p is an integer in the range of 1 to 20;

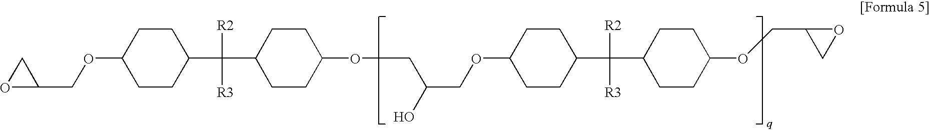

wherein R2 and R3 are the same as or different from each other, and independently each hydrogen or a C₁˜C₆ alkyl group, and q is an integer in the range of 0 to 2;

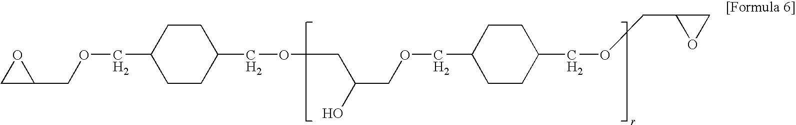

wherein r is an integer in the range of 0 to 2;

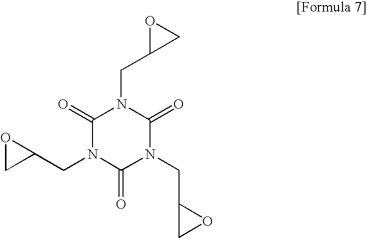

In the step (b), the curing agent may be one or more acid anhydride type curing agents that are selected from a phthalic anhydride, a maleic anhydride, a trimellitic acid anhydride, a pyromellitic anhydride, a hexahydrophthalic anhydride, a tetrahydrophthalic anhydride, a methyl nadic anhydride, a nadic anhydride, a glutaric anhydride, a methyl hexahydrophthalic anhydride, a methyl tetrahydrophthalic anhydride, a hydrogenated methyl nadic anhydride, and a hydrogenated nadic anhydride.

Here, if the methyl hexahydrophthalic anhydride and the hydrogenated methyl nadic anhydride are used, it is preferable that the transparent property of the film can be more improved. Preferably, in the acid anhydride type curing agent, the acid anhydride group of the acid anhydride type curing agent may be used in the amount of 0.5 to 1.5 equivalent, and more preferably 0.7 to 1.2 equivalent per 1 equivalent of the epoxy group of the epoxy resin.

In the case of the catalyst of the step (b), as the curing promoting agent, one or more that are selected from the group consisting of a tertiary amine, for example, 1,8-diazabicyclo[5.4.0]unde-7-cene, and triethylene diamine, imidasole, for example, 2-ethyl-4-methyl imidazole, and a phosphorus compound, for example, triphenyl phosphine, tetraphenyl phosphinium tetraphenyl borate, quartenary ammonium salt, organic metal salt, and a derivative thereof, may be used. Here, if the phosphorus compound is used, it is preferable that the transparent property of the film can be more improved.

In addition, as the above catalyst, the cationic catalyst may be used, and as the cationic catalyst, one or more that are selected from the organic acid, for example, an acetic acid, a benzoic acid, a salicylic acid, a para-toluene sulfonic acid, a boron trifluoride-amine complex, a boron trifluoride ammonium salt, an aromatic diazonium salt, an aromatic sulfonium salt, an aromatic iodonium salt, and an aluminium complex containing cationic catalyst may be used. The above curing promoting agent may be used alone or in a combination of two or more species.

The step (c) is a step for mixing the curable epoxy resin and the glass flake particle with each other, and if the mixing is easy and the transparent plastic film is capable of being produced, the used amount of the glass flake particle and the curable epoxy resin is not limited.

As an example, in the step (c), it is preferable that the curable epoxy resin and the glass flake particle are mixed with each other so that the content of the glass flake particle is less than 50% by weight in respects to the total solid portion in the mixture of the curable epoxy resin and the glass flake particle. More preferably, the content may be in the range of 1 to 50% by weight. As described above, the content of the glass flake particle may be less than 50% by weight, but can be more than 50% by weight.

Here, the total solid portion means the total amount of the curable epoxy resin and the glass flake particle.

As described above, even though the glass flake particle is added in the small amount, the thermal expansion coefficient (CTE) can be sufficiently reduced, and the light and thin transparent plastic film can be provided. In addition, since the glass flake particle per unit depth of the transparent plastic film can be included in a great amount, the gas barrier property for intercepting the gas is improved.

In a step for mixing the curable epoxy resin and the glass flake particle with each other in the step (c), if necessary, one or more filling agents that are selected from metal, an organic metal compound, glass powder, diamond powder, metal oxide and a clay may be further included.

As the metal, a general metal that is used in the art as the filling agent may be used.

As the organic metal compound, one or more that are selected from calcium phosphate, magnesium phosphate, barium sulfate, aluminium fluoride, calcium silicate, magnesium silicate, valium silicate, valium carbonate, valium hydroxide, aluminum silicate, and a mixture thereof may be used, but is not limited thereto.

As the metal oxide, one or more that are selected from the group consisting of silicon oxide (SiOₓ, here x is an integer in the range of 2-4) and aluminium oxide (Al₂Ox, here x is an integer in the range of 3-4), but are not limited thereto.

As for the clay, one or more that are selected from the group consisting of bentonite, smectite, and kaoline may be used, but are not limited thereto.

It is preferable that the size of the filling agent is in the range of more than 0 and 500 nm or less, and it is more preferable that it is in the range of more than 0 and 100 nm or less.

In the step (d), the curable epoxy resin that includes the glass flake particle is cured.

Therefore, the epoxy cured substance which includes the glass flake particle and in which a difference between the refractive indexes in respects to the glass flake particle is not more than 0.01 is formed. More preferably, the epoxy cured substance in which a difference between the refractive indexes in respects to the glass flake particle is not more than 0.005 may be used.

In the step (d), when the epoxy cured substance is formed by curing the curable epoxy resin that includes the glass flake particle, this can be shaped into the film shape. It is preferable that the epoxy cured substance is shaped to form a film that has the depth in the range of 20 to 200 μm.

As an example of a shaping method, injection shaping and lamination are preferable. In addition, in the case of when the solvent is used, the formation by the casting, the volatilization of the solvent, and the curing method are possible.

As described above, by using the method for controlling the refractive index of the curable epoxy resin on the basis of the refractive index of the glass flake particle, a difference between a refractive index after the curable epoxy resin is cured and a refractive index of the glass flake particle is not more than 0.01. In addition, a difference between the refractive indexes may be 0 and two refractive indexes may be the same as each other. Therefore, in order to control the refractive index, it is not necessary to separately produce the glass flake particle.

Since the refractive index of the curable epoxy resin is controlled on the basis of the refractive index of the glass flake particle, the transparent property of the film can be easily improved, and the transparent plastic film that has the excellent light transmittance can be produced.

On the other hand, the transparent plastic film according to the present invention comprise a glass flake particle; and an epoxy cured substance which includes the glass flake particle and in which a difference between the refractive index of the glass flake particle and the refractive index of the epoxy cured substance is not more than 0.01. Since the content in the description of the production method is all applied thereto, it will not be described in detail.

The depth of the glass flake particle may be not more than 1 μm, may be in the range of more than 0 and 0.1 μm or less, but is not limited thereto.

The content of the glass flake particle may be in the range of preferably more than 0 and 50% by weight or less and more preferably 1 to 50% by weight. The content of the glass flake particle may be not more than 50% by weight as described above, but can be more than 50% by weight.

The thermal expansion coefficient (CTE) of the transparent plastic film according to the present invention may be in the range of more than 0 and 80 ppm/K or less.

As an example thereof, the transparent plastic film may include the glass flake particle in which the depth is not more than 1 μm, and the thermal expansion coefficient (CTE) of the transparent plastic film may be in the range of more than 0 and 80 ppm/K or less. At this time, the content of the glass flake particle may be not more than 50% by weight, but is not limited thereto.

As an example thereof, the transparent plastic film may include the glass flake particle in which the depth is in the range of more than 0 and 0.1 μm or less, and the thermal expansion coefficient (CTE) of the transparent plastic film may be in the range of more than 0 and 60 ppm/K or less. At this time, the content of the glass flake particle may be not more than 50% by weight, but is not limited thereto.

As another example thereof, the transparent plastic film may include the glass flake particle in which the depth is in the range of more than 0 and 0.1 μm or less in the amount in the range of more than 0 and 20% by weight or less, and the thermal expansion coefficient (CTE) of the transparent plastic film may be in the range of more than 0 and 40 ppm/K or less.

The transparent plastic film according to the present invention can accomplish the thermal expansion coefficient that is in the above range by using the epoxy resin in which the refractive index is controlled without a method for adding another component to the glass flake.

The transparent plastic film according to the present invention may be used as a substrate for a display device, or a substrate for a solar cell of itself, and after a functional coating layer is formed on the transparent plastic film this may be used as a substrate for a display device, or a substrate for a solar cell.

Provided is an optical film that includes the transparent plastic film according to the present invention.

The optical film may further comprise an optical pattern that is formed on the transparent plastic film.

Here, the transparent plastic film according to the present invention may be used as a substrate of the optical film in which the optical pattern is formed, and the transparent plastic film may be used as the optical film without the optical pattern of itself.

Provided is a plastic substrate that comprises the transparent plastic film according to the present invention.

The plastic substrate according to the present invention may further include a gas barrier layer and/or an organic-inorganic hybrid layer. In detail, it may further include an organic-inorganic hybrid layer that is layered between the transparent plastic film and the gas barrier layer and/or the gas barrier layer.

The plastic substrate may further comprise one or more transparent plastic films according to the present invention.

In addition, the plastic substrate may be used as a substrate for a display device.

Here, as the display device, a liquid crystal display device (LCD), an organic light emitting device (OLED) and the like may be exemplified.

In a liquid crystal device that includes a thin film transistor array substrate; a color filter array substrate that is positioned opposite to the thin film transistor array substrate; and a liquid crystal that is injected between the thin film transistor array substrate and the color filter array substrate, the plastic substrate may be used as the thin film transistor array substrate and/or the color filter array substrate.

In an organic light emitting device that includes a substrate, a first electrode, an organic substance layer, and a second electrode, the plastic substrate may be used as the substrate.

Provided is an electronic device that includes the transparent plastic film according to the present invention. Here, as the electronic device, a display device for forming an image may be exemplified, but is not limited thereto.

On the other hand, the transparent plastic film according to the present invention comprise a glass flake particle; and an epoxy cured substance which includes the glass flake particle and in which a difference between the refractive index of the glass flake particle and the refractive index of the epoxy cured substance is not more than 0.01. Since the content in the description of the production method and the transparent plastic film is all applied thereto, it will not be described in detail.

### MODE FOR THE INVENTION

A better understanding of the present invention will be described in light of the following Examples which are set forth to illustrate, but are not to be construed to limit the present invention.

### Example 1

In order to produce the transparent plastic film, nitrogen was added to the round flask that has the volume of 500 ml and in which the agitation was possible for 30 min to remove residual oxygen, 182 parts by weight of a cycloaliphatic anhydride type of methyl hexahydro-nadic anhydride) (New Japan Chem., HNA-100) that is the epoxy curing agent, and 2 parts by weight of tetraphenyl phosphonium bromide (Aldrich, TPP-PB) that is the catalyst were added thereto, heated to 60° C., and agitated for 30 min. In addition, after 100 parts by weight of triglycidyl isocyanurate (triglycidyl isocyanurate) (Nissan Chem., TEPIC) was agitated at 130° C. for 10 min and dissolved, this was added to the epoxy curing agent that was previously prepared and to which the catalyst was added, and was agitated at normal temperature for 30 min to produce the epoxy resin for producing the transparent plastic film (the refractive index of the resin was 1.5250 after the curing). Here, 71 parts by weight of the glass flake particle (Model no. of the glass flake: GF10/production company: GLASSFLAKE Ltd./refractive index 1.52) that had the depth of 0.1 μm was added thereto, agitated for 60 min, and dispersed, and the residual bubbles were removed by using the vacuum to produce the epoxy resin that included the glass flake particles for the transparent plastic film.

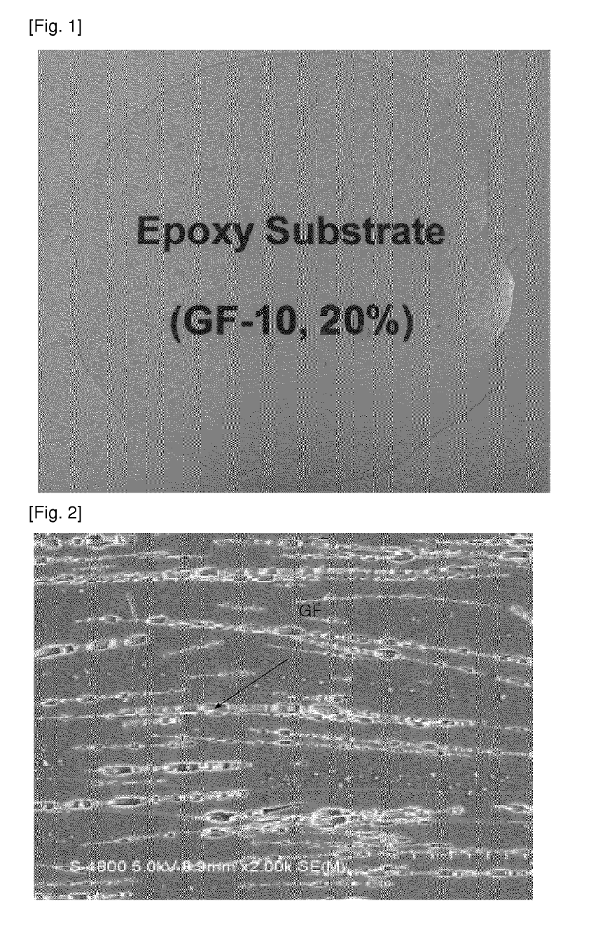

A process for shaping the produced epoxy resin that included the glass flake particles into the film is as follows. The epoxy resin that included the glass flake particle was coated on the first glass plate (STN glass plate having the depth of 0.7 mm) on which the release agent of the silicon oxide polymer component was coated, and the second glass plate on which the release agent was coated was covered on the epoxy resin that included the glass flake particle so that the bubbles are not formed. At this time, in order to produce the film that had the depth of 100 μm, the framework that had the depth of 100 μm was put on the edges between two glass plates. The glass plate to which the epoxy resin that included the glass flake particle was added was passed through the laminator device so that the depth of the resin was constantly made and fixed. The epoxy resin that included the glass flake particle that was fixed by two glass plates sequentially cured in the convection oven under the nitrogen atmosphere at 100° C. for 2 hours, at 120° C. for 2 hours, at 150° C. for 2 hours, and at 175° C. for 2 hours to produce the epoxy cured substance that included the glass flake particle, and the two glass plates were removed to produce the transparent plastic film that included the glass flake particle and the epoxy cured substance in which the glass flake particle was dispersed (see FIG. 1). The depth of the produced transparent plastic film was measured by the SEM, and the result was 100 μm (see FIG. 2).

### Example 2

The transparent plastic film was produced by using the same method as Example 1, except that the content of the glass flake particle was used in the amount of 32 parts by weight.

### Example 3

The transparent plastic film was produced by using the same method as Example 1, except that 71 parts by weight of the glass flake particle (Model No. of the glass flake: GF35/production company: GLASSFLAKE Ltd./refractive index 1.52) that had the depth of 0.35 μm was used instead of the glass flake particle that had the depth of 0.1 μm of Example 1.

### Example 4

The transparent plastic film was produced by using the same method as Example 1, except that 71 parts by weight of the glass flake particle (Model No. of the glass flake: GF100/production company: GLASSFLAKE Ltd./refractive index 1.52) that had the depth of 1.00 μm was used instead of the glass flake particle that had the depth of 0.1 μm of Example 1.

### Comparative Example 1

In the case of Comparative Example 1, the plastic film was produced by using the same method as Example 1, except that in the composition of TEPIC of the composition of Example 1, 50 parts by weight of TEPIC and 100 parts by weight of Bisphenol A-epoxy (Hexion chem., LER850) were used.

### Comparative Example 2

In the case of the resin of Comparative Example 2, 100 parts by weight of polyarylite, 25 parts by weight of the glass flake, and 800 parts by weight of the DCE (dichloroethane) solvent were used to produce the plastic film by using the casting method.

### Comparative Example 3

In the case of the resin of Comparative Example 3, the plastic film was produced by using the same method as Example 1, except that 91 parts by weight of a cycloaliphatic anhydride type of methyl hexahydro-nadic anhydride) (New Japan Chem., HNA-100) that is the epoxy curing agent of the composition of Example 1 was used.

TABLE 1

| | Refractive index | | | Linear | Glass | Refractive index |
|---|---|---|---|---|---|---|
| | of the epoxy cured | GF | Light | expansion | transition | of the epoxy |
| | substance not | content | transmittance | coefficient | temperature | cured substance |
| | including GF (nD) | (wt %) | (400 nm) | (ppm/K) | (° C.) | including GF (nD) |
| Example 1 | 1.525 | 20 | 82 | 20 | >220 | 1.520 |
| Example 2 | 1.525 | 10 | 80 | 40 | >220 | 1.520 |
| Example 3 | 1.525 | 20 | 81 | 58 | >220 | 1.520 |
| Example 4 | 1.525 | 20 | 79 | 67 | >220 | 1.520 |
| Comparative | 1.545 | 10 | 52 | 42 | 166 | 1.537 |
| Example 1 | | | | | | |
| Comparative | 1.620 | 20 | 0 | 22 | 205 | — |
| Example 2 | | | | | | |
| Comparative | 1.532 | 20 | 73 | 22 | 219 | 1.529 |
| Example 3 | | | | | | |

* The refractive index of GF10, GF35, and GF100: 1.52

The measurement method of the physical properties are as follows, and were identically applied to all Examples and Comparative Examples. All the described physical properties were expressed by the average value in respect to minimum 5 or more measurement values so that it statistically had the representativeness.

1) Light transmittance: on the basis of ASTM D1003, they were measured in the range of 380 to 780 nm that was the visible ray range by using the UV-spectrometer (Varian, Co., Ltd., Cary 3E).

2) Thermal expansion coefficient: on the basis of ASTM D696, the thermal expansion coefficient was heated by using the thermomechanical analysis (TMA; Seiko instrument, Co., Ltd., SSC/5200) under the stress of 5 gf at the rate of 10° C. per unit and measured.

3) Glass transition temperature: the glass transition temperature was heated by using the Differential Scanning Calorimeter (DSC; TA Instrument, Co., Ltd., DSC2010) at the rate of 10° C. per unit and measured.

4) Refractive index: the refractive index was measured by using the optical property analysis device (ATAGO, DR-M4) at 589 nm.

As described in Table 1, in the transparent plastic film that included the glass flake particle and the epoxy cured substance in which the glass flake particle was dispersed according to Example 1, the light transmittance of 82%, the low thermal expansion coefficient of 20 ppm/K, the glass transition temperature of 220° C. or more, and the refractive index value of 1.520 were shown.

In addition, in the transparent plastic film according to Example 2, the light transmittance of 80%, the low thermal expansion coefficient of 40 ppm/K, the glass transition temperature of 220° C. or more, and the refractive index value of 1.520 were shown.

In the transparent plastic film according to Example 3, the light transmittance of 81%, the low thermal expansion coefficient of 58 ppm/K, the glass transition temperature of 220° C. or more, and the refractive index value of 1.520 were shown.

In the transparent plastic film according to Example 4, the light transmittance of 79%, the low thermal expansion coefficient of 67 ppm/K, the glass transition temperature of 220° C. or more, and the refractive index value of 1.520 were shown.

As described above, on the basis of the refractive index of the glass flake particle, in the case of the transparent plastic films according to Example 1 to 4 of the present invention that were produced by using a method for controlling the refractive index of the curable epoxy resin is used, after the curable epoxy resin was cured, since a difference between its refractive index and the refractive index of the glass flake particle is 0, it could be seen that the refractive indexes of the two things were the same as each other. Therefore, the light transmittance of about 80% or more and the excellent transparent property can be provided.

On the other hand, in the case of the plastic films according to Comparative Example 1 and Comparative Example 2, as shown in Table 1, it could be confirmed that since the light transmittance was too low or light could not permeate thereto, they could not be used as the transparent film. In addition, in the case of the plastic film according to Comparative Example 3, a difference between the refractive index of the epoxy cured substance and the refractive index of the glass flake is more than 0.01, and it could be seen that the light transmittance was reduced.

1. A method for producing a transparent plastic film, the method comprising the steps of:
(a) preparing a glass flake particle;
(b) preparing a curable epoxy resin in which a difference between a refractive index after the curable epoxy resin is cured and a refractive index of the glass flake particle is not more than 0.01;
(c) mixing the curable epoxy resin and the glass flake particle with each other; and
(d) curing a mixture of the curable epoxy resin and the glass flake particle to form an epoxy curing substance that includes the glass flake particle.

2. The method for producing a transparent plastic film as set forth in claim 1, wherein in the step (a), the glass flake particle that has the depth of not more than 1 μm is used.

3. The method for producing a transparent plastic film as set forth in claim 1, wherein in the step (a), the glass flake particle with a ratio (L/D) of length per depth that is not less than 50 is used.

4. The method for producing a transparent plastic film as set forth in claim 1, wherein in the step (b), 20 to 1000 parts by weight of a curing agent is further included on the basis of 100 parts by weight of the curable epoxy resin.

5. The method for producing a transparent plastic film as set forth in claim 1, wherein in the step (b), the curable epoxy resin is one or more that are selected from an alicyclic epoxy resin that is represented by the following Formula I to Formula 6 and triglycidyl isocyanurate that is represented by the following Formula 7: 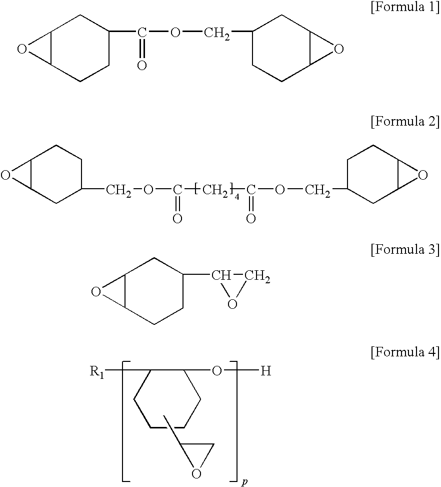
wherein R₁ is a C₁˜C₆ alkyl group or a trimethylolpropane residual group, and p is an integer in the range of 1 to 20; 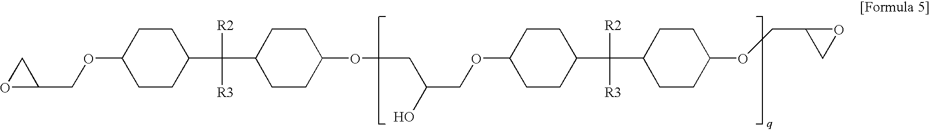
wherein R2 and R3 are the same as or different from each other, and independently each hydrogen or a C₁˜C₆ alkyl group, and q is an integer in the range of 0 to 2; 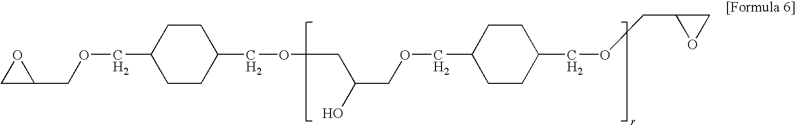
wherein r is an integer in the range of 0 to 2;

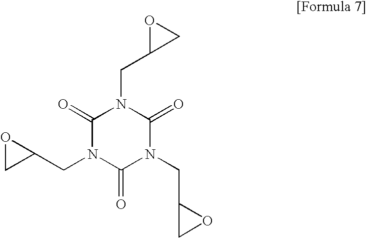

6. The method for producing a transparent plastic film as set forth in claim 4, wherein in the step (b), the curing agent is one or more acid anhydride type curing agents that are selected from a phthalic anhydride, a maleic anhydride, a trimellitic acid anhydride, a pyromellitic anhydride, a hexahydrophthalic anhydride, a tetrahydrophthalic anhydride, a methyl nadic anhydride, a nadic anhydride, a glutaric anhydride, a methyl hexahydrophthalic anhydride, a methyl tetrahydrophthalic anhydride, a hydrogenated methyl nadic anhydride, and a hydrogenated nadic anhydride.

7. The method for producing a transparent plastic film as set forth in claim 4, wherein in the step (b), 0.1 to 5 parts by weight of a catalyst is further included on the basis of 100 parts by weight of the curable epoxy resin.

8. The method for producing a transparent plastic film as set forth in claim 7, wherein the catalyst of the step (b) is one or more curing promoting agents that are selected from the group consisting of 1,8-diazabicyclo[5.4.0]unde-7-cene, triethylene diamine, 2-ethyl-4-methyl imidazole, triphenyl phosphine, tetraphenyl phosphinium, tetraphenyl borate, quartenary ammonium salt, organic metal salt, and a derivative thereof.

9. The method for producing a transparent plastic film as set forth in claim 7, wherein in the step (b), the catalyst is one or more that are selected from an acetic acid, a benzoic acid, a salicylic acid, a para-toluene sulfonic acid, a boron trifluoride-amine complex, a boron trifluoride ammonium salt, an aromatic diazonium salt, an aromatic sulfonium salt, an aromatic iodonium salt, and an aluminium complex containing cationic catalyst.

10. The method for producing a transparent plastic film as set forth in claim 1, wherein in the step (b), the step for preparing the curable epoxy resin comprises:
(b1) mixing 20 to 1000 parts by weight of the curing agent and 0.1 to 5 parts by weight of the catalyst with each other on the basis of 100 parts by weight of the curable epoxy resin; and
(b2) mixing the curing agent to which the catalyst is added and 100 parts by weight of the curable epoxy resin with each other.

11. The method for producing a transparent plastic film as set forth in claim 1, wherein in the step (c), one or more filling agents that are selected from metal, an organic metal compound, glass powder, diamond powder, metal oxide and a clay are further added.

12. (canceled)

13. The method for producing a transparent plastic film as set forth in claim 1, wherein in the step (d), the epoxy cured substance is shaped into a film that has the depth in the range of 20 to 200 μm.

14. A transparent plastic film comprising:
a glass flake particle; and
an epoxy cured substance which includes the glass flake particle and in which a difference between the refractive index of the glass flake particle and the refractive index of the epoxy cured substance is not more than 0.01.

15. The transparent plastic film as set forth in claim 14, wherein the depth of the glass flake particle is in the range of more than 0 and 1 μm or less.

16. The transparent plastic film as set forth in claim 14, wherein the thermal expansion coefficient (CTE) of the transparent plastic film is more than 0 and 80 ppm/K or less.

17. The transparent plastic film as set forth in claim 14, wherein the depth of the glass flake particle is in the range of more than 0 and 1 μm or less, and the thermal expansion coefficient (CTE) of the transparent plastic film is in the range of more than 0 and 80 ppm/K or less.

18. (canceled)

19. (canceled)

20. (canceled)

21. The transparent plastic film as set forth in claim 14, further comprising:
one or more filling agents that are selected from metal, an organic metal compound, glass powder, diamond powder, metal oxide and clay.

22. (canceled)

23. An optical film comprising:
the transparent plastic film according to claim 14.

24. A plastic substrate comprising:
the transparent plastic film according to claim 14.

25. The plastic substrate as set forth in claim 24, further comprising:
a gas barrier layer.

26. The plastic substrate as set forth in claim 24, further comprising:
an organic-inorganic hybrid layer.

27. (canceled)

28. An electronic device comprising:
the transparent plastic film according to claim 14.

29. A transparent complex material comprising:
a glass flake particle; and
an epoxy cured substance which includes the glass flake particle and in which a difference between the refractive index of the glass flake particle and the refractive index of the epoxy cured substance is not more than 0.01.

30. The transparent complex material as set forth in claim 29, wherein the depth of the glass flake particle is in the range of more than 0 and 1 μm or less.

31. The transparent complex material as set forth in claim 29, wherein the thermal expansion coefficient (CTE) of the transparent plastic film is in the range of more than 0 and 80 ppm/K or less.

32. The transparent complex material as set forth in claim 29, wherein the depth of the glass flake particle is in the range of more than 0 and 1 μm or less, and the thermal expansion coefficient (CTE) of the transparent plastic film that includes the glass flake particle is in the range of more than 0 and 80 ppm/K or less.

33. (canceled)

34. (canceled)

35. (canceled)

36. The transparent complex material as set forth in claim 29, further comprising:
one or more filling agents that are selected from metal, an organic metal compound, glass powder, diamond powder, metal oxide and a clay.

37. (canceled)
